(19) United States
(12) Patent Application Publication
(10) Pub. No.: US 2017/0007951 A1
(43) Pub. Date: Jan. 12, 2017

(54) Magnetic Vent Filter

(71) Applicant: David M. DeChristofaro, Niles, OH (US)

(72) Inventor: David M. DeChristofaro, Niles, OH (US)

(21) Appl. No.: 15/205,145

(22) Filed: Jul. 8, 2016

Related U.S. Application Data
(60) Provisional application No. 62/190,842, filed on Jul. 10, 2015.

(51) Int. Cl. B01D 46/00; F24F 13/28; B01D 46/10

(52) U.S. Cl. CPC B01D 46/0005; B01D 46/0001; B01D 46/10; F24F 13/28; B01D 2265/06; B01D 2265/023; B01D 2279/35; B01D 2265/04

(57) ABSTRACT

A magnetic vent filter that is washable and readily removable from a grill or vent register. The filter includes a first frame, a second frame, a filter, adhesive and fasteners. The first and second frames each have a planar perimeter rim with first and second sides. The filter is secured between the first side of the planar perimeter rim of the second frame and the second side of the planar perimeter rim of the first frame by adhesive. The first and the second frames are secured together in the same manner, the adhesive preventing movement of the second frame relative to the first frame, and securing the filter therebetween. Magnetic fasteners are attached to the vent filter, to a side of a planar perimeter rim of the first and the second frame, and then attach to a register or grille of a vent.

### RELATED INVENTIONS

This application claims benefit of priority of U.S. Provisional Application No. 62/190,842, filed Jul. 10, 2016, entitled “Magnetic Vent Filter,” which application is incorporated herein by reference.

### FIELD OF THE INVENTION

The present invention relates to a register or grille for a vent. More specifically, the present invention is a magnetic vent filter that is washable and readily removable from a vent. The present invention comprises a first frame, a second frame, a filter, and an adhesive. The first frame is beneath the second frame. The first and the second frame surround the filter that is sealed between the first and the second frame. The first frame comprises a fastening means that connects the magnetic vent filter to a vent installed within a floor or wall. The preferred embodiment of the fastening means is a magnetic strip on either distal end of the first frame. The preferred embodiment of the frame comprises grid-like patterns and designs for easy washing and effective filtering of dirt, dust and other airborne particles that may enter the ducts.

### BACKGROUND OF THE INVENTION

Registers and grilles for floor and wall ventilation direct the air flow and prevents items from falling into or out of the vent. Traditional registers and grilles however do not actively prevent dirt, dust, and airborne air particles from entering the vent or blowing out of the ducts. This lack of filtering proves to be damaging to the environment within a room or space. Additional accessories have attempted to solve this problem, but none have effectively done so while being able to provide long-term use, as well as ease and convenience of use.

The present invention serves to filter any unwanted debris from vents. A vent filter of the present invention comprises a first frame, a second frame, a filter, and an adhesive. The first frame comprises a fastening means that connects the vent filter to a vent. A preferred embodiment of the fastening means is one or more magnetic strips that allow for a durable attachment of the vent filter to a vent and an easy removal. The filter is fixed between the first and second frames and prevents any unwanted materials from leaving the vent and entering the room or space. The filter is washable such that any smell or bacteria from debris that may have attached onto the filter is not being blown into the room or space.

### SUMMARY OF THE INVENTION

The present invention provides a magnetic vent filter that is washable and readily removable from a vent. The vent filter includes a first frame, a second frame, a filter, adhesive and fastening means. One frame is beneath the other frame. Generally, the first and the second frames surround the filter that is sealed therebetween. One frame includes a fastening means that connects the magnetic vent filter to a vent installed within a floor or wall. The fastening means can be a magnetic strip on either distal end of a frame. The first and the second frames can include grid-like patterns and designs for easy washing and effective filtering of dirt, dust and other airborne particles that may enter the ducts.

In one embodiment, the vent filter includes a first frame having a planar perimeter rim, the planar perimeter rim including a first side and a second side. The filter is secured to the first or the second side of the planar perimeter rim of the first frame by adhesive. Magnetic fasteners are attached to the first or the second side of the planar perimeter rim of the first frame. The magnetic fasteners attach the vent filter to a register or grille of a vent.

In another embodiment, the vent filter further includes a second frame having a planar perimeter rim, the planar perimeter rim also including a first side and a second side. In this embodiment, the first side of the planar perimeter rim of the second frame is attached to the second side of the planar perimeter rim of the first frame. The filter is secured between the first side of the planar perimeter rim of the second frame and the second side of the planar perimeter rim of the first frame by adhesive, whereby the adhesive prevents movement of the second frame relative to the first frame and secures the filter therebetween. The first side of the planar perimeter rim of the first frame or the second side of the planar perimeter rim of the second frame includes magnetic fasteners to attach the vent filter to a register or grille of a vent. The first frame and the second frame cab each have a rectangular shape in cross-section, and can each mirror one another.

In a further embodiment, the vent filter is defined by a length, a width and a depth. The depth is defined by the first frame adhered to the second frame with the filter therebetween. The planar perimeter rims of the first and of the second frames extend about an entirety of the length and width, and at least the first frame further includes a plurality of bars extending between the planar perimeter rim of the frame, across the width of the vent filter.

In this embodiment, from a center axis of the vent filter, to which the plurality of bars are parallel, and extending to each lengthwise end of the vent filter, the plurality of bars can be sequentially spaced with ever decreasing distance therebetween. The second frame can also include a similar plurality of bars extending between the planar perimeter rim of the second frame, across the width of the vent filter. The first and the second frames can therefore mirror one another, and the filter can be further secured between each of the plurality of bars of the first and of the second frames.

In an alternative to the further embodiment, at least the first frame of the vent filter further includes a plurality of bars extending between the planar perimeter rim, across the width of the vent filter and along the length of the vent filter. In this alternative embodiment, from a longitudinal axis of the vent filter, to which the plurality of bars extending along the length of the vent filter are parallel, and extending to each widthwise end of the vent filter, the plurality of bars can be sequentially spaced with ever decreasing distance therebetween. The second frame can also include a similar plurality of bars extending between the planar perimeter rim of the second frame, across the width of the vent filter and along the length of the vent filter. The first and the second frames can therefore mirror one another, and the filter can be further secured between each of the plurality of bars of the first and of the second frames. In one aspect, from a center axis of the vent filter, to which the plurality of bars extending across the width of the vent filter are parallel, and extending to each lengthwise end of the vent filter, the plurality of bars can be sequentially spaced with varying distances therebetween. In another aspect, the plurality of bars extending between the planar perimeter rim of the first and the second frames, across the width of the vent filter and along the length of the vent filter, can have varying thicknesses.

The vent filter can be provided in a kit, where the first frame, second frame, filter, adhesive and fastening means are separately provided. The frames can be made of an elastomer that is easily cut to size such that vent filter may accommodate a variety of vent openings. Alternatively, the vent filter can be molded, injection molded, or manufactured by heat welding, where the vent filter (i.e., the filter and frames) is provided together.

Accordingly, the present invention also involves a method for preparing a vent filter for use, by first providing a vent filter in accordance with one of the various described embodiments. A user may then acquire measurements of a grill or register of a vent for use of the vent filter; cut along an outer edge of, or along a bar of, the first and the second frames of the vent filter, similarly cutting each of the first and the second frames, such that a perimeter of the first and the second frames mirror each other and are associated with the measurements of the grill or register. After similarly sizing the filter, the user would then fasten the filter between the first and the second frames, assuring the filter is secured within and around an entirety of outer edges of the first and the second frames, and that the outer edges of the first and the second frames are coincident with one another. The fastening means would then be applied to a side of the outer edge of the first or the second frame, and the vent filter would then be attached to the grill or register of the vent.

If the vent filter is prefabricated, for example by injection molding, the user would acquire measurements of a grill or register of a vent for use of the vent filter; cut along an outer edge of, or along a bar of, the first and the second frames of the vent filter, similar cutting each of the first and the second frames, such that a perimeter of the first and the second frames mirror each other and are associated with the measurements of the grill or register. The user then applies the fastening means to a side of the outer edge of the first or the second frame, and attaches the vent filter to the grill or register of the vent.

### BRIEF DESCRIPTION OF THE ILLUSTRATED EMBODIMENTS

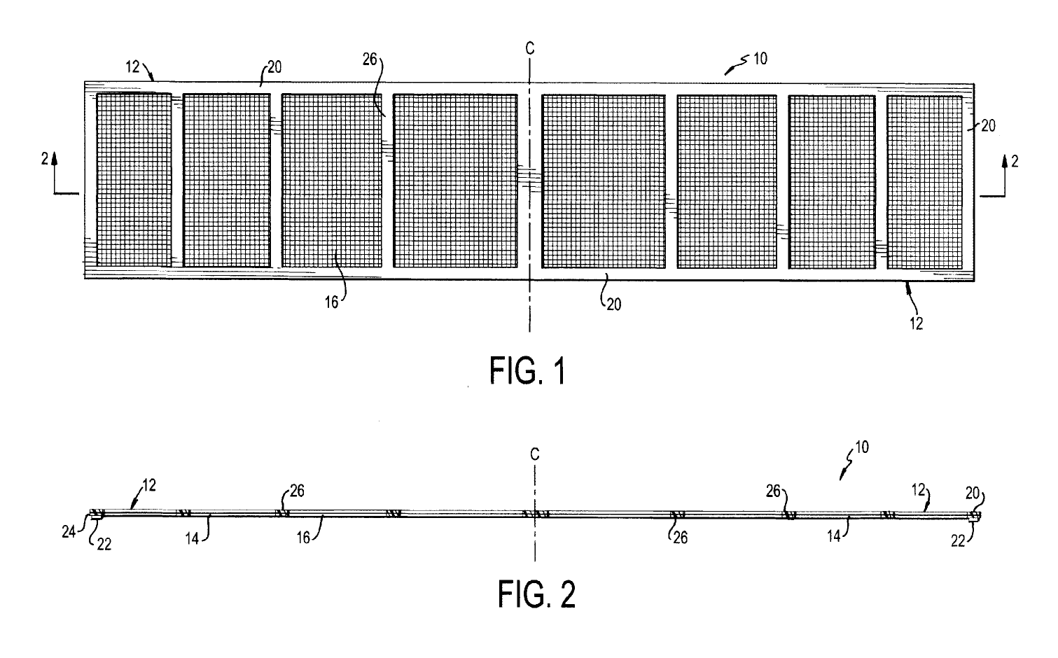

FIG. 1 is a top view of a first embodiment of the present invention;

FIG. 2 is a section view of the first embodiment shown in FIG. 1;

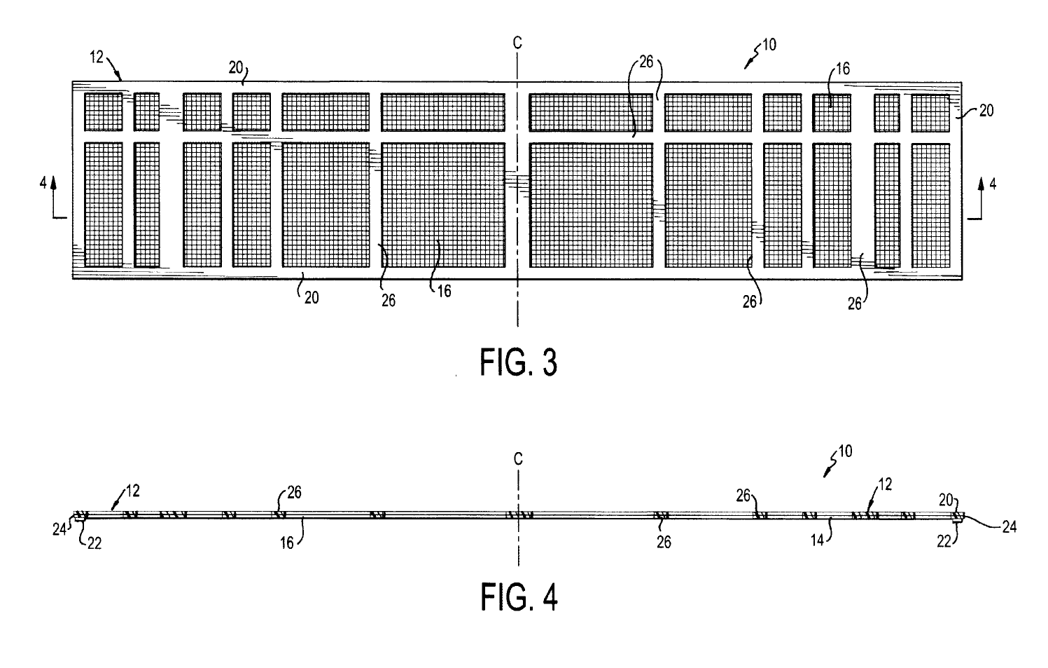

FIG. 3 is a top view of a second embodiment of the present invention;

FIG. 4 is a section view of the second embodiment shown in FIG. 3;

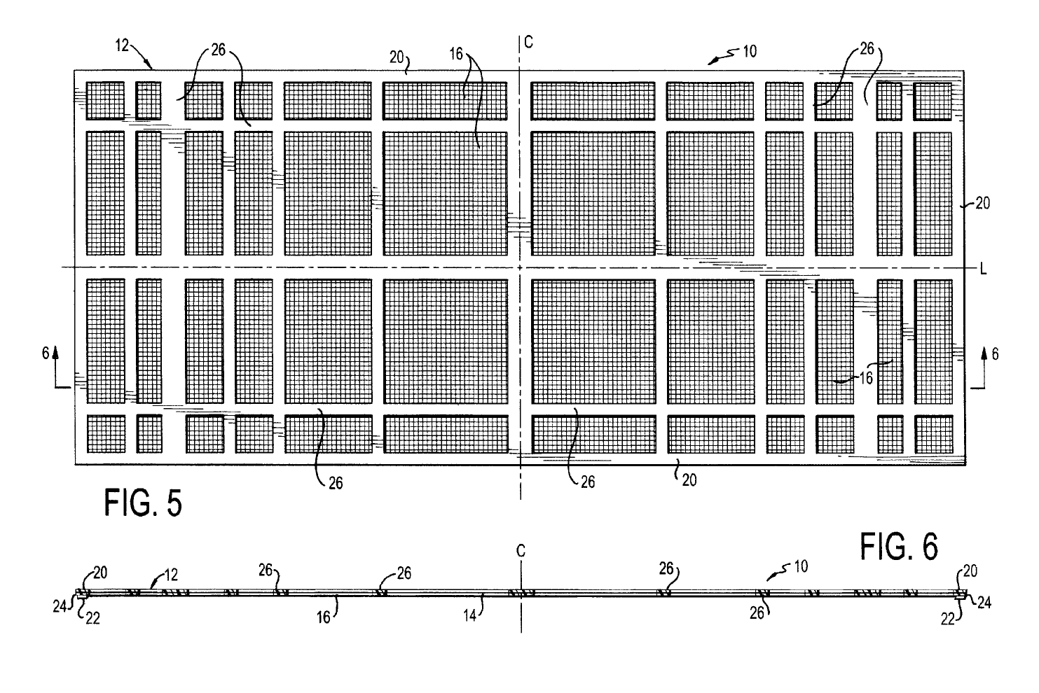

FIG. 5 is a top view of a third embodiment of the present invention; and

FIG. 6 is a section view of the third embodiment shown in FIG. 5.

### DETAILED DESCRIPTION OF THE ILLUSTRATED EMBODIMENTS

All illustrations of the drawings are for the purpose of describing selected versions of the present invention and are not intended to limit the scope of the present invention.

As generally illustrated in FIGS. 1-6, the vent filter 10 of the present invention comprises a first frame 12, a second frame 14, a filter 16, and an adhesive (not shown). The first frame 12 includes a planar rim 20 that comprises a cross-sectional shape that can mirror a perimeter of a register or grille of a vent. The preferred embodiment of the first frame 12 comprises a rectangular cross-sectional shape. The first frame 12 also comprises a fastening means 22. The fastening means 22 is fixed beneath the first frame 12 and provides fastening between the vent filter 10 and the vent opening. The fastening means 22 can be one or more magnetic strips that comprise an adhesive layer and a magnetic layer. The adhesive layer is placed adjacent to the first frame 12 and the magnetic layer opposite the first frame. The preferred embodiment of the vent filter 10 of the present invention includes a couple of fastening means 22, placed on opposite distal ends of the first frame 12. The preferred embodiment of the couple of fastening means 22 comprises magnetic materials for easy attachment and removal of the vent filter 10 to the vent opening. The preferred embodiment of the couple of fastening means 22 provide a magnetic attachment between the vent filter 10 and components of the vent opening. An alternate embodiment of the present invention may comprise more or less than a couple of fastening means 22. A further alternate embodiment of the fastening means 22 may comprise Velcro® strips or any other comparable fastening means that allows reattaching.

In one embodiment (not shown specifically), the vent filter 10 comprises just a first frame 12, a filter 16, and an adhesive. The filter 16 is adhered to the first frame 12 along a side of the planar rim 20 of the first frame 12. In this embodiment, fastening means 22 is provided as detailed above. This embodiment can also include one or more bars 26, extending across the vent filter 10, from opposite or adjacent edges of the planar rim 20, in vertical, horizontal or diagonal directions, as further detailed below. The bars 26 could also be variably spaced, and have varying widths, or thicknesses, as further detailed below. In this regard, this embodiment of the vent filter 10 could resemble either of FIG. 1, 3 or 5, from a top view, without including the second frame 14, shown attached to the first frame 12, in respective FIG. 2, 4, or 6.

In another embodiment of the vent filter 10, a second frame 14 is attached to the face, or side, of the first frame 12 via the adhesive (not shown). The combination of the first and the second frame 12, 14 protect the filter 16 from any damage, prevent any items from entering the vent opening, and surround the perimeter of the filter 16 (adhered between the planar rim 20 of the first frame 12 and a planar rim 24 of the second frame 14). The planar rim 24 of the second frame 14 can mirror that of (e.g., have similar dimensions to) the planar rim 20 of the first frame. The first and/or the second frames 12, 14 can further include one or more bars 26 extending across the vent filter 10, from opposite or adjacent edges of the planar rim 20. The second frame 14 rests upon or against (is adhered to) the first frame 12 with the filter 16 in between, as shown in respective FIGS. 2, 4 and 6.

The filter 16 of the various embodiments is a mesh-like cover that prevents any debris from escaping past the vent and entering the room or space that corresponds to the vent opening. The filter 16 comprises materials of typical vent filters, such as polypropylene, polyethylene, polyvinyl, nylon, polyester, or other filter material. The filter 16 preferably includes perimeter dimensions similar to that of the first and/or the second frames 12, 14, providing for easy and complete adherence to the planar rim 20 of the first frame 12, or between the planar rims 20, 24 of the first and the second frames 12, 14. Accordingly, the filter 16 should include perimeter dimensions larger than an inner perimeter (inside of the planar rim 20, 24) of the first and the second frames 12, 14. In either instance, a preferred embodiment of the filter 16 involves a size allowing one or both respective frames 12, 14 to completely conceal edges of the filter 16.

The adhesive (not shown) fastens the filter 16 to the first frame 12, in one embodiment, or between the first and the second frames 12, 14, in other embodiments. The adhesive prevents movement of the second frame 14 from the first frame 12 and secures the position of the filter 16. The preferred embodiment of the adhesive comprises materials like that of lamination adhesives or any other durable adhesive that is preferably water-resistant.

One preferred embodiment of the vent filter 10 of the present invention comprises a first and a second frame 12, 14 having a height (thickness) of approximately one-thirty second of an inch each, and a length of eighteen inches. In one preferred embodiment of the vent filter 10, a width is four inches. In another preferred embodiment, the depth is eight inches.

In further embodiments of the vent filter 10, one or both frames 12, 14 have one or more bars 26 extending between the planar perimeter rim 20, 24 of the respective frame 12, 14, across a width of the vent filter 10 (laterally). As shown in FIG. 1, these bars are vertical in relation to the frame 12 as shown. In one aspect, from a center axis C of the vent filter 10, to which the plurality of bars 26 are parallel, this embodiment may include a spacing between each of the plurality of bars 26 that sequentially decreases from the center axis C to each lengthwise end of the vent filter 10, as shown in FIG. 1. The plurality of bars 26 can have varying thicknesses. In another aspect, both the first frame 12 and the second frame 14 have a similar plurality of bars 26, the first 12 and the second 14 frames thereby mirroring one another, as shown in FIG. 2. In such an embodiment, the filter 16 can be further secured between each of the plurality of bars 26 of the first 12 and of the second 14 frames.

In still further embodiments of the vent filter 10, one or both frames 12, 14 have one or more bars 26 extending both longitudinally and laterally across the respective frame 12, 14, as shown in FIGS. 3 and 5. The plurality of bars 26 can have varying thicknesses, longitudinally and/or laterally. In one aspect, from a longitudinal axis L of the vent filter 10, to which the plurality of bars 26 extending along the length of the vent filter are parallel, and extending to each widthwise end of the vent filter 10, the plurality of bars 26 are sequentially spaced with ever decreasing distance therebetween (see FIG. 5). In another aspect, from a center axis C of the vent filter 10, to which the plurality of bars 26 extending across the width of the vent filter 10 are parallel, and extending to each lengthwise end of the vent filter 10, the plurality of bars 26 are sequentially spaced with varying distances therebetween (see FIGS. 3 and 5). In another aspect, this plurality of bars 26 are sequentially spaced with ever-decreasing distance therebetween.

In a preferred embodiment of the vent filter 10, the frames 12, 14 are made of an elastomer that is easily cut to size such that first and second frames 12, 14 may accommodate a variety of vent openings.

To properly engage the vent filter 10 of the present invention, a user acquires dimensions of a vent opening. The user takes the vent filter 10 of the present invention and cuts along the outer edges such that the perimeter of the first and second frames 12, 14 mirror each other. The filter 16 is fastened between the frames 12, 14 and is contained within the outer edges of the register or grille of a vent. The filter 16 is located between the first and second frames 12, 14 with the second frame 14 beneath the first frame 12. The user can thereby customize the first and second frames 12, 14 of the vent filter 10. Preferably, inner edges of first and second frame 12, 14 correspond to the inner edges of the register or grill of the vent. Preferably the filter 16 encompasses an entire space between the inner edges of the first and second frame 12, 14 and does not exceed the outer edges of the first and second frames 12, 14.

In a manufacturing or assembly process, adhesive (not shown) is applied to the planar rims 20, 24 and the plurality of bars 26 of the first and of the second frames 12, 14, such that the filter 16 is secure between the first and the second frames 12, 14. Accordingly, outer edges of the first and the second frames 12, 14 are coincident with one another. The filter 16 exposed within the inner perimeter of the first and the second frames 12, 14, and between the one or more bars 26, should remain undisturbed by the adhesive.

The user then applies the fastening means of the first frame 12, beneath and on a side of a respective frame 12, 14. The user presses the adhesive layer of the fastening means 22 against the exposed face of the respective frame 12, 14, so that the magnetic layer is opposite the respective frame 12, 14. The user may then apply the vent filter 10 to the desired vent. The magnetic layer of the fastening means 22 is drawn to the register or grille of the vent. The vent filter 10 remains attached to the vent unless otherwise purposefully removed.

If the vent filter 10 is of an embodiment including one frame, the one frame is cut to size, as described above, the filter is adhered to the planar rim (and any included bars) of the one frame, and the fastening means is attached to an planar rim underside.

As installed, the filter 16 prevents any debris from escaping past the opening of the supply air vent and entering the room or space corresponding to the vent. The filter 16 also prevents any debris from escaping past the opening of the return air vent and entering the return air duct system of the HVAC system. The vent filter 10 may be removed from the vent for cleaning purposes. The user simply lifts the vent filter 10 from the vent and rinses the filter 16 with water or any appropriate cleaning liquid to remove any attached debris. The user lets the filter 16 dry, and then covers the register or grille of the vent once again.

Although the invention has been explained in relation to its preferred embodiment, it is to be understood that many other possible modifications and variations can be made without departing from the spirit and scope of the invention. Such variation may include but are not limited to, molding the filter and the frames together; heat welding the filter and the frames together, as well as other variations.

If a molded vent filter 10 is used, the user would cut the entire vent filter to size, based on dimensions of a vent opening, as described above, and attach the fastening means a remaining planar rim, as described above, and apply to the grille or register of the vent.

What is claimed is:

1. A vent filter, comprising:
a first frame having a planar perimeter rim, the planar perimeter rim including a first side and a second side;
a filter secured to the first or the second side of the planar perimeter rim of the first frame by adhesive; and
magnetic fasteners attached to the first or the second side of the planar perimeter rim of the first frame, the magnetic fasteners attaching the vent filter to a register or grille of a vent.

2. The vent filter of claim 1, further comprising:
a second frame having a planar perimeter rim, the planar perimeter rim including a first side and a second side, wherein:
the first side of the planar perimeter rim of the second frame is attached to the second side of the planar perimeter rim of the first frame;
the filter is secured between the first side of the planar perimeter rim of the second frame and the second side of the planar perimeter rim of the first frame by adhesive, whereby the adhesive prevents movement of the second frame relative to the first frame and secures the filter therebetween; and
the first side of the planar perimeter rim of the first frame or the second side of the planar perimeter rim of the second frame includes magnetic fasteners to attach the vent filter to a register or grille of a vent.

3. The vent filter of claim 2, wherein the first frame and the second frame each have a rectangular shape in cross-section.

4. The vent filter of claim 2, wherein the planar perimeter rims of the first and the second frames mirror one another.

5. The vent filter of claim 2, wherein the filter consists of one or more materials selected from the group consisting of polypropylene, polyethylene, polyvinyl, nylon, polyester, and other filter material.

6. The vent filter of claim 2, the vent filter defined by a length, a width and a depth, wherein:
the depth is defined by the first frame adhered to the second frame with the filter therebetween;
the planar perimeter rims of the first and of the second frames extend about an entirety of the length and width; and
at least the first frame further includes a plurality of bars extending between the planar perimeter rim of the frame, across the width of the vent filter; and
from a center axis of the vent filter, to which the plurality of bars are parallel, and extending to each lengthwise end of the vent filter, the plurality of bars are sequentially spaced with ever decreasing distance therebetween.

7. The vent filter of claim 6, wherein:
the second frame also includes a similar plurality of bars extending between the planar perimeter rim of the second frame, across the width of the vent filter:
the first and the second frames mirror one another; and
the filter is further secured between each of the plurality of bars of the first and of the second frames.

8. The vent filter of claim 2, the vent filter defined by a length, a width and a depth, wherein:
the depth is defined by the first frame adhered to the second frame with the filter therebetween;
the planar perimeter rims of the first and of the second frames extend about an entirety of the length and width; and
at least the first frame further includes a plurality of bars extending between the planar perimeter rim of the first frame, across the width of the vent filter and along the length of the vent filter.

9. The vent filter of claim 8, wherein:
the second frame also includes a similar plurality of bars extending between the planar perimeter rim of the second frame, across the width of the vent filter and along the length of the vent filter:
the first and the second frames mirror one another; and
the filter is further secured between each of the plurality of bars of the first and of the second frames.

10. The vent filter of claim 9, wherein, from a longitudinal axis of the vent filter, to which the plurality of bars extending along the length of the vent filter are parallel, and extending to each widthwise end of the vent filter, the plurality of bars are sequentially spaced with ever decreasing distance therebetween.

11. The vent filter of claim 9, wherein, from a center axis of the vent filter, to which the plurality of bars extending across the width of the vent filter are parallel, and extending to each lengthwise end of the vent filter, the plurality of bars are sequentially spaced with varying distances therebetween.

12. The vent filter of claim 9, wherein the plurality of bars extending between the planar perimeter rim of the first and the second frames, across the width of the vent filter and along the length of the vent filter, have varying thicknesses.

13. A vent filter, comprising:
a first frame having a planar perimeter rim, the planar perimeter rim including a first side and a second side,
a second frame having a planar perimeter rim, the planar perimeter rim including a first side and a second side, the first side of the planar perimeter rim of the second frame attached to the second side of the planar perimeter rim of the first frame, the second side of the planar perimeter rim of the second frame including magnetic fasteners to attach the vent filter to a register or grille of a vent; and
a filter secured between the first side of the planar perimeter rim of the second frame and the second side of the planar perimeter rim of the first frame by adhesive, whereby the adhesive prevents movement of the second frame relative to the first frame and secures the filter therebetween;
wherein:
the vent filter is defined by a length, a width and a depth:
the depth is defined by the first frame adhered to the second frame with the filter therebetween;
the planar perimeter rims of the first and of the second frames extend about an entirety of the length and width of the vent filter;
the first and the second frames each further include a plurality of bars extending between respective planar perimeter rims of the first and the second frames, across the width of the vent filter;
from a center axis of the vent filter, to which the plurality of bars are parallel, and extending to each lengthwise end of the vent filter, the plurality of bars are sequentially spaced with ever decreasing distance therebetween;
the first frame and the second frame each have a rectangular shape in cross-section;
the first and the second frames mirror one another; and
the filter is further secured between each of the plurality of bars of the first and of the second frames.

14. A vent filter, comprising:
a first frame having a planar perimeter rim, the planar perimeter rim including a first side and a second side,
a second frame having a planar perimeter rim, the planar perimeter rim including a first side and a second side, the first side of the planar perimeter rim of the second frame attached to the second side of the planar perimeter rim of the first frame, the second side of the planar perimeter rim of the second frame including magnetic fasteners to attach the vent filter to a register or grille of a vent; and
a filter secured between the first side of the planar perimeter rim of the second frame and the second side of the planar perimeter rim of the first frame by adhesive, whereby the adhesive prevents movement of the second frame relative to the first frame and secures the filter therebetween;
wherein:
the vent filter is defined by a length, a width and a depth;
the depth is defined by the first frame adhered to the second frame with the filter therebetween;
the planar perimeter rims of the first and of the second frames extend about an entirety of the length and width; and
the first and the second frames further include a plurality of bars extending between the respective planar perimeter rims of the first and the second frames, across the width of the vent filter and along the length of the vent filter;
the plurality of bars extending between the respective planar perimeter rim of the first and the second frames, across the width of the vent filter and along the length of the vent filter, have varying thicknesses;
from a center axis of the vent filter, to which the plurality of bars extending across the width of the vent filter are parallel, and extending to each lengthwise end of the vent filter, the plurality of bars are sequentially spaced with varying distances therebetween.
from a longitudinal axis of the vent filter, to which the plurality of bars extending along the length of the vent filter are parallel, and extending to each widthwise end of the vent filter, the plurality of bars are sequentially spaced with ever decreasing distance therebetween.
the first frame and the second frame each have a rectangular shape in cross-section;
the first and the second frames mirror one another; and
the filter is further secured between each of the plurality of bars of the first and of the second frames.

15. A method of preparing a vent filter for use, the method comprising the steps of:
providing a vent filter of claim 13;
acquiring measurements of a grill or register of a vent for use of the vent filter;
cutting along an outer edge of, or along a bar of, the first and the second frames of the vent filter, similar cutting each of the first and the second frames, such that a perimeter of the first and the second frames mirror each other and are associated with the measurements of the grill or register;
similarly sizing and then fastening the filter between the first and the second frames, assuring the filter is secured within and around an entirety of outer edges of the first and the second frames, and that the outer edges of the first and the second frames are coincident with one another;
applying an fastening means to a side of the outer edge of the first or the second frame; and
attaching the vent filter to the grill or register of the vent.

16. A method of preparing a vent filter for use, the method comprising the steps of:
providing a vent filter of claim 14;
acquiring measurements of a grill or register of a vent for use of the vent filter;
cutting along an outer edge of, or along a bar of, the first and the second frames of the vent filter, similar cutting each of the first and the second frames, such that a perimeter of the first and the second frames mirror each other and are associated with the measurements of the grill or register;
similarly sizing and then fastening the filter between the first and the second frames, assuring the filter is secured within and around an entirety of outer edges of the first and the second frames, and that the outer edges of the first and the second frames are coincident with one another;
applying an fastening means to a side of the outer edge of the first or the second frame; and
attaching the vent filter to the grill or register of the vent.

17. A method of preparing a vent filter for use, the method comprising the steps of:
providing a molded vent filter of claim 13;
acquiring measurements of a grill or register of a vent for use of the vent filter;
cutting along an outer edge of, or along a bar of, the first and the second frames of the vent filter, similar cutting each of the first and the second frames, such that a perimeter of the first and the second frames mirror each other and are associated with the measurements of the grill or register;
applying an fastening means to a side of the outer edge of the first or the second frame; and
attaching the vent filter to the grill or register of the vent.

18. A method of preparing a vent filter for use, the method comprising the steps of:
providing a molded vent filter of claim 14;
acquiring measurements of a grill or register of a vent for use of the vent filter;
cutting along an outer edge of, or along a bar of, the first and the second frames of the vent filter, similar cutting each of the first and the second frames, such that a perimeter of the first and the second frames mirror each other and are associated with the measurements of the grill or register;
applying an fastening means to a side of the outer edge of the first or the second frame; and
attaching the vent filter to the grill or register of the vent.
